(19) United States
(12) Patent Application Publication
(10) Pub. No.: US 2010/0102667 A1
(43) Pub. Date: Apr. 29, 2010

(54) MOTOR HOUSING STRUCTURE

(75) Inventors: SHAO-CHUNG YUAN, Tu-Cheng (TW); YIN-JAO LUO, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: FOXNUM TECHNOLOGY CO., LTD., Tucheng City (TW)

(21) Appl. No.: 12/406,075

(22) Filed: Mar. 17, 2009

(30) Foreign Application Priority Data
Oct. 23, 2008 (CN) 200810305117.5

(51) Int. Cl. H02K 1/18

(52) U.S. Cl. 310/216.065

(57) ABSTRACT

A motor housing structure includes a first cover, a stator, and a second cover. The first cover is fixed to the one end of the stator. The second cover is fixed to the other end of the stator. The second cover defines a slanted annular groove. One lower end of the groove defines an opening.

### BACKGROUND

1. Technical Field

The disclosure generally relates to motors, and particularly to a motor housing structure.

2. Description of Related Art

In motor manufacturing process, varnish is used to enable a motor housing structure insulation. The motor housing structure includes a first cover, a stator, and a second cover. The first cover and the second cover are fastened to the opposite ends of the stator. After the motor housing structure is impregnated with varnish. The motor housing structure need to be tilted, the varnish in a groove of the second cover could outflow from an opening of the groove. But the motor housing structure is not easy to move because it is very heavy.

What is needed, therefore, is a motor housing structure addressing the limitations described above.

### BRIEF DESCRIPTION OF THE DRAWINGS

FIG. 1 is an exploded, perspective view of a motor housing structure in accordance with an embodiment of the disclosure.

FIG. 2 is a sectional view of a motor housing structure of FIG. 1.

### DETAILED DESCRIPTION OF THE EMBODIMENTS

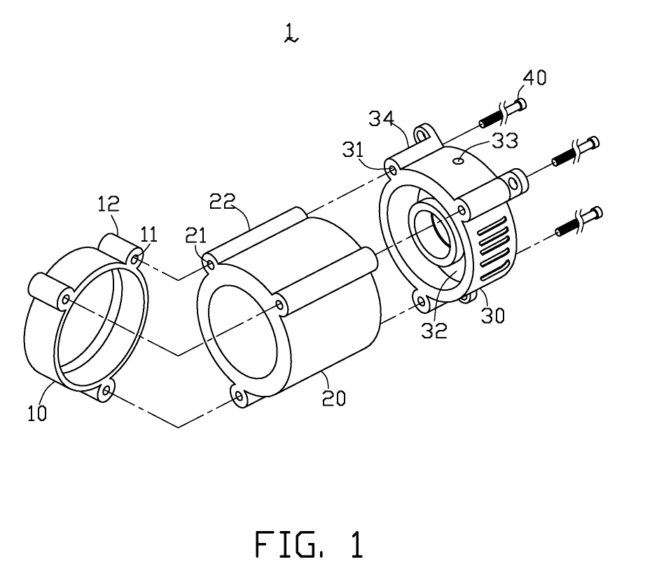

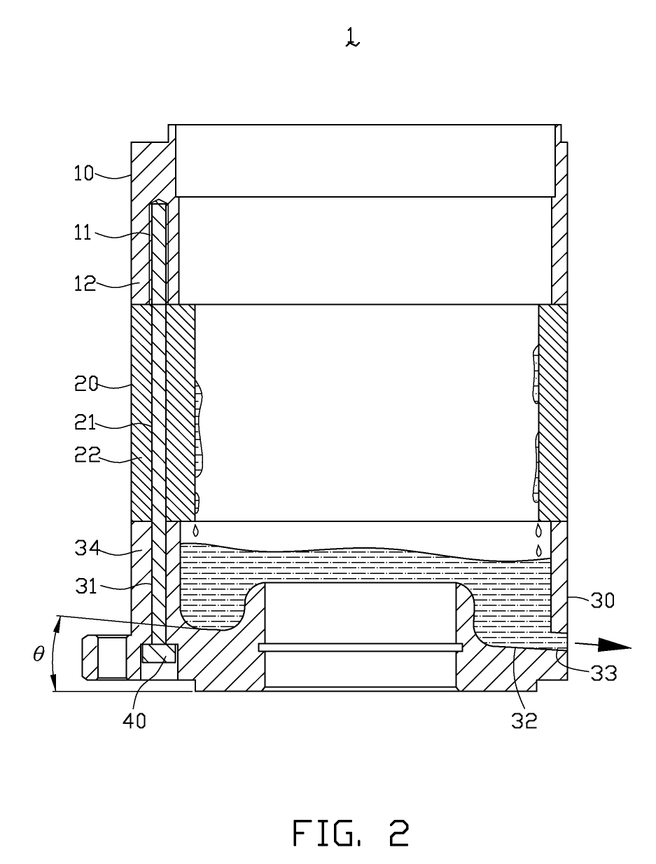

Referring to FIGS. 1 and 2, a motor housing structure 1 accordance with an embodiment includes a first cover 10, a stator 20, a second cover 30 and a plurality of fasteners 40.

The second cover 30 is a hollow cylinder. The second cover 30 defines a slanted annular groove 32. One lower end of the groove 32 defines an opening 33. The slant angle θ of a bottom surface of the groove 32 is from 1° to 5°. An outer wall of the second cover 30 defines a plurality of retaining portions 34 each having a through hole 31.

The stator 20 is a hollow cylinder. An outer wall of the stator 20 defines a plurality of retaining portions 22 each having a through hole 21 corresponding to the through holes 31 of the second cover 30. The stator 20 stacks by silicon steel sheet.

The first cover 10 is a hollow cylinder. An outer wall of the first cover 10 defines a plurality of retaining portions 12 each having a screw hole 11 corresponding to the through holes 21 of the stator 20.

In assembly, the first cover 10 and the second cover 30 are fastened to the opposite ends of the stator 20 by the plurality of fasteners 40. Then, threading the each fastener 40 through the corresponding through hole 31 of the second cover 30, and the through hole 21 of the stator 20 into the screw hole 11 of the first cover 10.

In use, the motor housing structure 1 is vertically placed on the floor and the second cover 30 is located at the bottom. The motor housing structure 1 is impregnated with varnish. Because the groove is slanted an angle and the lower end of the groove 32 having the opening 33. The varnish outflow from the opening 33 of the groove 32 without the need to slant the motor housing structure 1.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A motor housing structure comprising:
a stator;
a first cover fixed to one end of the stator;
a second cover fixed to another end of the stator, the second cover having annular groove with a slanted bottom, one lower end of the groove having an opening.

2. The motor housing structure as claimed in claim 1, wherein the slant angle of the bottom of the groove is from 1° to 5°.

3. The motor housing structure as claimed in claim 1, wherein an outer wall of the second cover defines a plurality of retaining portions each having a through hole, an outer wall of the stator defines a plurality of retaining portions each having a through hole corresponding to the through holes of the second cover, an outer wall of the first cover defines a plurality of retaining portions each having a screw hole corresponding to the through holes of the stator, the first cover and the second cover are fastened to the opposite ends of the stator by a plurality of fasteners, threading the each fastener through the corresponding through hole of the second cover, and the through hole of the stator into the screw hole of the first cover.

4. The motor housing structure as claimed in claim 3, wherein the stator stacks by silicon steel sheet.

5. The motor housing structure as claimed in claim 3, wherein the stator is hollow-cylinder shaped.

6. The motor housing structure as claimed in claim 3, wherein the first cover is hollow-cylinder shaped.

7. The motor housing structure as claimed in claim 3, wherein the second cover is hollow-cylinder shaped.
